(19) United States
(12) Patent Application Publication
(10) Pub. No.: US 2014/0174300 A1
(43) Pub. Date: Jun. 26, 2014

(54) BEVERAGE FILTER ASSEMBLY

(71) Applicant: Koninklijke Douwe Egberts B.V., Utrecht (NL)

(72) Inventors: David Ian Husband, Bentleigh (AU); Rebecca Bartel, Eltham (AU); Antonius J. Peters, Naperville, IL (US)

(73) Assignee: Koninklijke Douwe Egberts B.V., Utrecht (NL)

(21) Appl. No.: 14/195,714

(22) Filed: Mar. 3, 2014

Related U.S. Application Data
(63) Continuation of application No. PCT/NL2012/050597, filed on Aug. 31, 2012.
(60) Provisional application No. 61/530,633, filed on Sep. 2, 2011.

(51) Int. Cl. A47J 31/40; B65D 85/804

(52) U.S. Cl. CPC A47J 31/407; B65D 85/8046
USPC 99/323; 426/77

(57) ABSTRACT

Beverage filter kit usable with a brewing the kit comprising a reusable insert configured to be received within a brewing cavity of the brewing device; and a disposable filter assembly configured to be received within the insert and comprising a substance suitable for preparing a brewed beverage. Filter assembly usable with a brewing device, the filter assembly comprising a paper-based lid portion; a paper-based filter portion; and a substance contained between the lid portion and the filter portion suitable for preparing a brewed beverage; the filter assembly is configured to be received within a brewing chamber of the brewing device. Reusable insert usable with a filter assembly and brewing device for preparation of a brewed beverage, the insert comprising a top, a bottom, and a sidewall forming a cavity to receive a filter assembly, the filter assembly comprising a substance for preparing a brewed beverage; a plurality of elongated protrusions extending along at least a portion of the sidewall between the top and the bottom; and an aperture provided on the bottom to provide an exit for a brewed beverage flowing through the filter assembly within the insert.

### CROSS-REFERENCE TO RELATED APPLICATIONS

This Application is a continuation of International Patent Application No. PCT/NL2012/050597, filed on Aug. 31, 2012, which claims the benefit of priority to U.S. Provisional Application No. 61/530,633, filed on Sep. 2, 2011, all of which are hereby incorporated herein by reference in their entireties.

### BACKGROUND

The present disclosure relates generally to the field of beverage filter assemblies, and more specifically, to beverage filter assemblies usable with brewing devices such as coffee machines to produce brewed beverages such as coffee and the like.

### SUMMARY

One embodiment relates to a beverage filter kit usable with a brewing device, the kit comprising a reusable insert configured to be received within a brewing cavity of the brewing device; and a disposable filter assembly configured to be received within the insert and comprising a substance suitable for preparing a brewed beverage.

Another embodiment relates to a filter assembly usable with a brewing device, the filter assembly comprising a paper-based lid portion; a paper-based filter portion; and a substance contained between the lid portion and the filter portion suitable for preparing a brewed beverage; wherein the filter assembly is configured to be received within a brewing chamber of the brewing device.

Another embodiment relates to a reusable insert usable with a filter assembly and brewing device for preparation of a brewed beverage, the insert comprising a top, a bottom, and a sidewall forming a cavity configured to receive a filter assembly, the filter assembly comprising a substance suitable for preparing a brewed beverage; a plurality of elongated protrusions extending along at least a portion of the sidewall between the top and the bottom; and an aperture provided on the bottom to provide an exit for a brewed beverage flowing through the filter assembly within the insert.

### BRIEF DESCRIPTION OF THE DRAWINGS

FIG. 1 shows a beverage filter assembly and filter insert being positioned within a portion of a brewing device according to an exemplary embodiment.

FIG. 2 shows the filter assembly and insert of FIG. 1 removed from the brewing device according to an exemplary embodiment,

FIG. 3 is cross-sectional schematic representation of the filter assembly and insert of FIG. 1 positioned within a brewing device according to an exemplary embodiment.

FIG. 4 is a schematic representation of a method of manufacturing the filter assembly of FIG. 1 according to an exemplary embodiment.

FIGS. 5-12 show various filter assemblies and related components and packaging according to various alternative embodiments.

### DETAILED DESCRIPTION OF EXEMPLARY EMBODIMENTS

Some brewing devices are configured to receive disposable filter cartridges. The cartridge is inserted into a brewing cavity of the brewing device. The brewing device includes a brewing chamber to receive a cartridge, and access to the brewing chamber may be via a moveable handle, a cover, etc. A user places the cartridge into the brewing chamber of the brewing device and initiates the brewing process. A first piercing member of the brewing device penetrates the top of the pod and introduces a fluid, such as hot water, into the interior of the pod, which typically contains a substance such as coffee granules. The hot water passes through the coffee granules, extracting coffee flavoring from the coffee granules before passing through a filter material within the pod. A second piercing member of the brewing device pierces the bottom of the pod and provides an exit path for the brewed beverage to leave the pod and be directed to a cup or other container used for consumption by users.

Various embodiments disclosed herein relate to beverage filter assemblies and other components used with brewing devices to produce brewed beverages such as coffee. Conventional filter cartridges, or pods, usable for single servings of coffee or similar brewed beverage, include a plastic cup having a foil lid, where a filter material is provided within the cup and holds a substance such as coffee suitable for producing a brewed beverage. The filter assemblies and similar components disclosed herein may provide many advantages over conventional pods, including providing a filter assembly (e.g., a “soft” pod) with fewer raw materials than conventional pods, and providing a “greener” product that is comprised mostly or all of “green” components (e.g., recyclable, bio-degradable, and/or paper-based or similar materials).

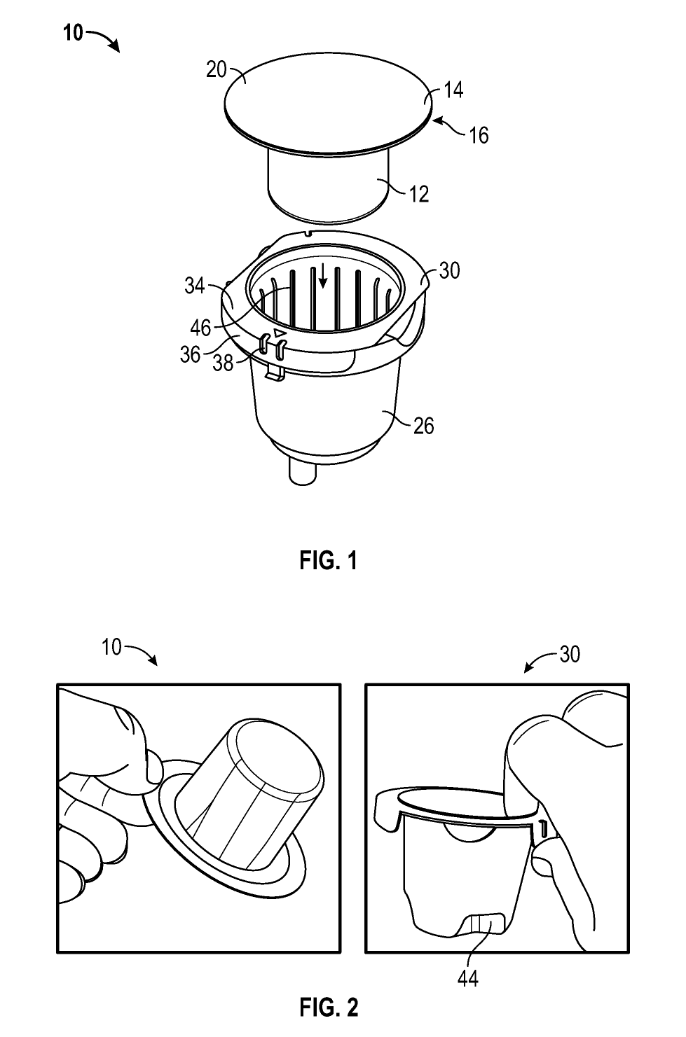

Referring to FIG. 1, a beverage filter assembly 10 and an insert 30 are shown being positioned within a portion of a brewing device 26 according to an exemplary embodiment. Filter assembly 10 and insert 30 may be usable with a wide variety of brewing devices, including coffee machines and the like. According to one embodiment, filter assembly 10 is designed for one-time use and is intended to be discarded after use by a consumer, while insert 30 may be a more durable, multi-use component suitable for repeated use, and intended to be periodically cleaned/washed by consumers. As such, filter assembly 10 and insert 30 may be sold as separate items (e.g., as separate individual items or groups of items) or as a group (e.g., with multiple filter assemblies being sold together with a single insert).

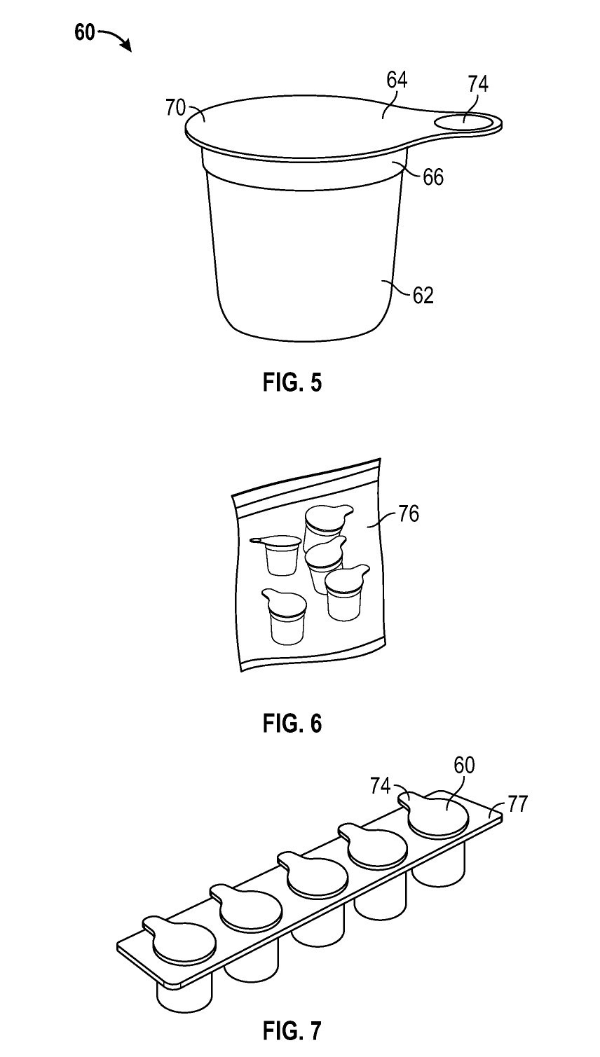

Referring to FIGS. 1-3, filter assembly 10 includes a filter 12, a cover or lid 14, and optionally a support member or ring 16. A substance 18 suitable for preparing a brewed beverage (e.g., coffee, etc.) is contained within an interior defined by filter 12 and lid 14. Substance 18 may include substances such as coffee grounds/granules, tea, one or more additives (e.g., a creamer, sugar, etc.), and the like, which are usable to extract flavorings, etc. into a liquid such as hot water to produce a brewed beverage. The substance(s) may partially or totally dissolve within a liquid during the brewing cycle. Filter 12 may be sealed (e.g., bonded, adhered, heat sealed, etc.) to lid 14 in a manner such that a flange, or lip 20 is formed around all or a portion of the perimeter of the top of filter assembly 10. Ring 16 may be a generally annular, flat member configured to provide structural support and/or rigidity to filter assembly 10. In some embodiments, filter assembly 10 may be provided without ring 16.

According to one embodiment, lid 14 is a paper-based component (e.g., cardboard, etc.) made primarily or completely from paper or paper-based products. For example, lid 14 may be made of a cardboard material that provides sufficient rigidity to maintain the shape of filter assembly 10 during packaging, transportation, use, etc., yet permits a suitable brewing device to penetrate the lid in order to introduce liquid (e.g., hot water, etc.) into the interior of the filter assembly.

Filter 12 may be made of any suitable filter material. As shown in FIGS. 1-3, filter 12 may form a basket-shaped interior extending downward from lid 14. Most or all of the interior formed by filter 12 may be filled with a suitable substance such as coffee granules or the like. In order to form the generally cylindrical sidewalls and bottom of filter 12, portions of filter 12 may be folded over one-another, or pleated, where filter 12 is attached to lid 14.

In one embodiment, ring 16 is bonded to filter 12 and/or lid 14 and is made of a polymer material. In some embodiments, ring 16 and/or lid 14 may be made of resilient materials that facilitate formations of seals between filter assembly 10 and both insert 30 and brewing device 26. Thus, seals may be formed between ring 16/lid 14 and insert 30, and between lid 14 and brewing device 26, to prevent liquid from escaping from filter assembly 10 during the brewing process. In cases where filter assembly 10 is provided without ring 16, lid 14 may provide seals with both insert 30 and brewing device 26. Lid 14 and/or ring 16 may further facilitate insertion and/or removal of filter assembly to/from insert 30 and/or brewing device 26.

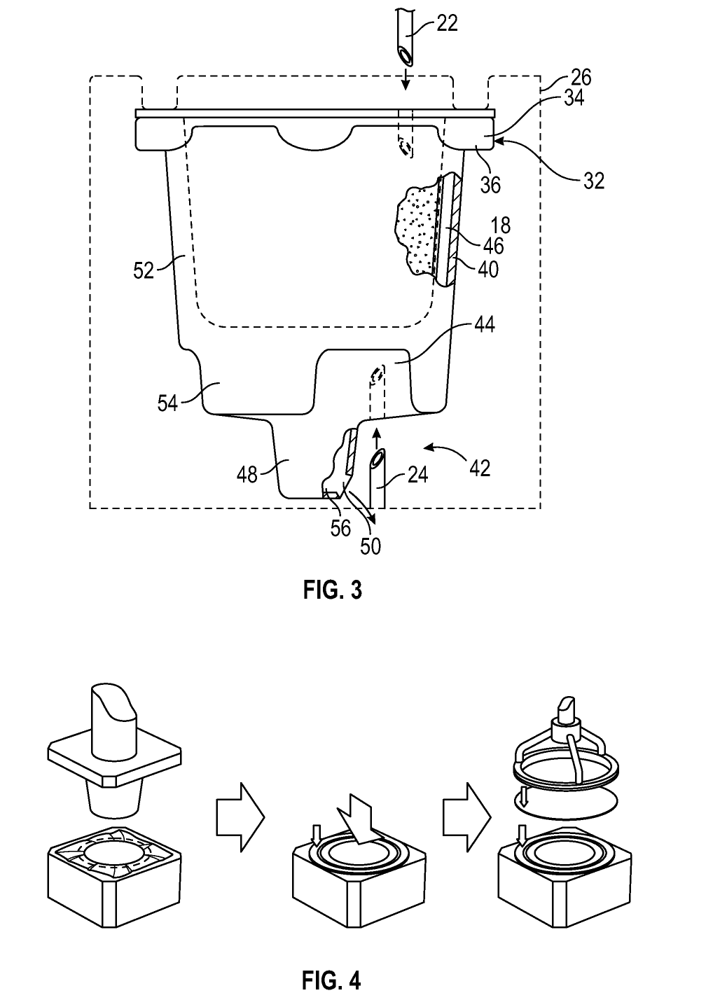

Insert 30 includes a top 32, a bottom 42, and a sidewall 40 extending between top 32 and bottom 42 to form an interior brewing cavity 52. Top 32 may include one or more flanges 34 having downward extending lips 36. One or more apertures 38 may be defined by flanges 34 and/or lips 36. Flanges 34, lips 36, and/or apertures 38 may be shaped, sized, and/or positioned so as to properly orient, or register, insert 30 within a particular brewing device such as brewing device 26. Flanges 34 and/or lips 36 may further facilitate the insertion and/or removal of insert 30 to/from brewing device 26 by acting as a graspable portion for users to hold (see e.g., FIG. 2).

Sidewall 40 of insert 30 may include a plurality of ridges/grooves, shown as elongated protrusions 46 (e.g., channels, ribs, protrusions, etc.) or similar features extending along the height of sidewall 40 on the interior surface thereof. Protrusions 46 may be spaced apart about the perimeter of insert 30 and may extend along substantially the entire height of sidewall 40. According to an alternative embodiment, protrusions 46 may extend along sidewall 40 only for the portion of sidewall 40 that abuts or is adjacent to filter 12, such that protrusions 46 may not extend fully down to bottom 42 of insert 30.

A wide variety of shapes may be used to form protrusions 46, including U-shaped channels, wave-shapes, zig-zags, corrugations, etc. In one embodiment, protrusions 46 are configured such that when a filter assembly such as filter assembly 10 is positioned within cavity 52 of insert 30, and a liquid such as hot water is introduced into the filter assembly, the sides of the filter assembly do not tend to “stick” to sidewall 40 of insert 30, but rather at least intermittent spacing is maintained (e.g., as a result of the contour of the protrusions, grooves, etc.) between filter assembly 10 and sidewall 40 of insert 30.

Bottom 42 of insert 30 includes one or more (e.g., 3, etc.) upward extending recesses 44. In one embodiment, recesses 44 are “pie-shaped” when viewed from the bottom of insert 30 and extend into cavity 52. In some embodiments, recesses 44 are shaped, sized, and/or positioned such that a bottom piercing member 24 of brewing device 26, which would typically pierce more conventional filter pods, is received within the space defined by recess 44 and does not enter into brewing cavity 52 of insert 30. The configuration of recesses 44 may be varied to suit a particular filter assembly and/or brewing device according to various alternative embodiments.

Insert 30 further includes a downward extending post 48 that extends from the central portion of bottom 42 and defines an aperture, or drain 50. Post 48 includes an interior 56 (e.g., a reservoir, cavity, etc.) configured to collect a brewed beverage exiting from filter assembly 10 such that the brewed beverage is directed out of insert 30 via drain 50. Post 48 and/or drain 50 may be shaped, sized, and/or positioned to direct a brewed beverage exiting insert 30 to any suitable location within brewing device 26. The size and/or shape of drain 50 may further be varied to control the rate at which a brewed beverage exits from insert 30.

In use, a user may first position insert 30 within brewing device 26. As mentioned above, insert 30 may include alignment features such as flanges 34, lips 36, apertures 38, and or other features that align, or register, insert 30 into a proper position within brewing device 26. Next, a user may place filter assembly 10 into cavity 52 of insert 30. A user may then initiate the brewing process on brewing device 26, such that upper piercing member 22 pierces lid 14 of filter assembly 10 and introduces a liquid (e.g., hot water) into filter assembly 10. As the liquid flows through substance 18 within filter assembly 10, filter 12 may “swell” toward sidewall 40 of insert 30. Protrusions 46 on sidewall 40 prevent filter 12 from “sticking” to sidewall 40, thereby promoting efficient flow of fluid around the perimeter of filter 12 and ensuring an appropriate distribution of fluid among and around the granules of substance 18. As the brewed beverage flows out of the bottom of filter 12, it collects within void or space 54 within insert 30, and travels downward into interior 56 of post 48, where it exits from insert 30 via drain 50. It should be noted that in some embodiments, filter assembly 10 may be configured for use with a brewing device without the use of an insert such as insert 30.

After the brewing cycle is complete, used filter assembly 10 may be removed from brewing device 26 and discarded, and insert 30 may be washed and reused with additional filter assemblies. In some embodiments, filter assembly may have a compressed, or crushed, appearance after use, providing a visual indication to users that the filter assembly has been used and may be discarded. As noted above, in some embodiments filter assembly 10 is a substantially “green” product, made from recyclable and/or biodegradable products (e.g., paper-based products, etc.) that are generally more “environmentally friendly” than other materials such as plastics, metals, and other similar materials. One or more labels may provide an indication that the filter assembly is recyclable, “compostable,” or the like.

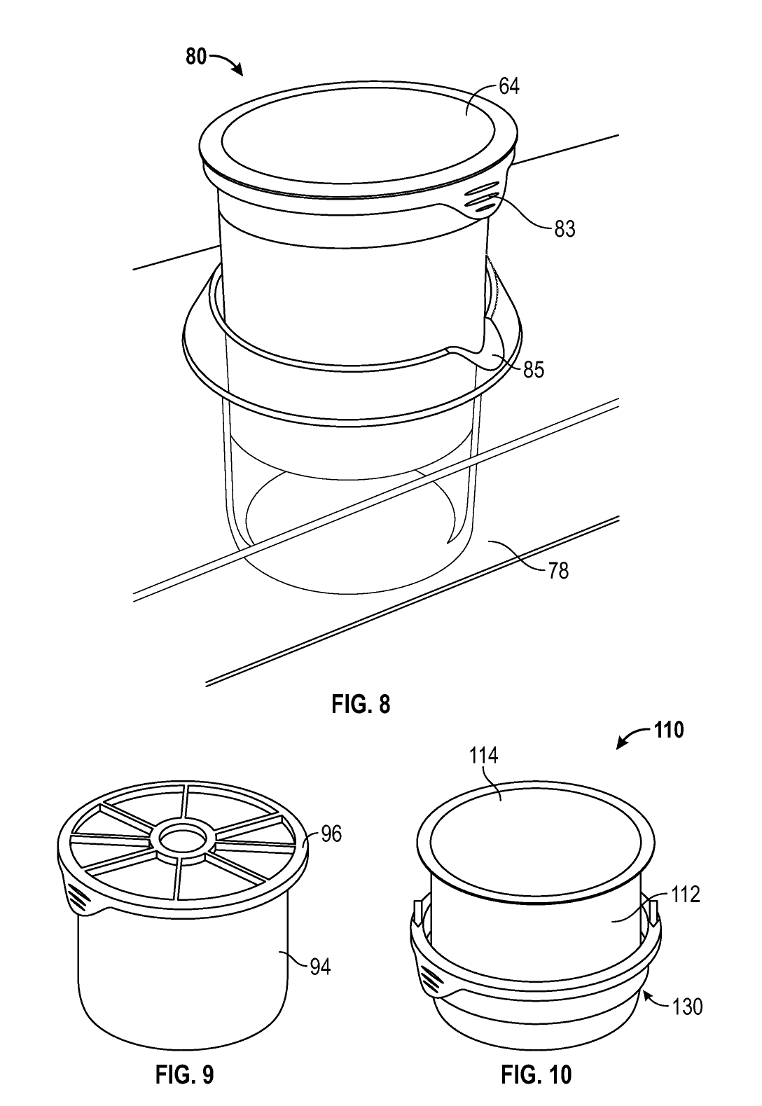

Referring now to FIG. 4, a schematic representation of a process for manufacturing a filter assembly such as filter assembly 10 is shown according to an exemplary embodiment. First, a filter such as filter 12 may be formed and trimmed to the appropriate size and shape using a heat forming/trimming tool. Next, the formed and trimmed filter, and optionally, a support ring such as ring 16, may be placed in a suitable fixture or jig (e.g., a heat sealing fixture or jig, etc.). While in the fixture, a substance such as coffee granules or a similar substance may be loaded into the formed and trimmed filter. A cover or lid such as lid 14 may then be sealed (e.g., heat sealed, etc.) to the filter (and if used, the support ring) to form a completed filter assembly.

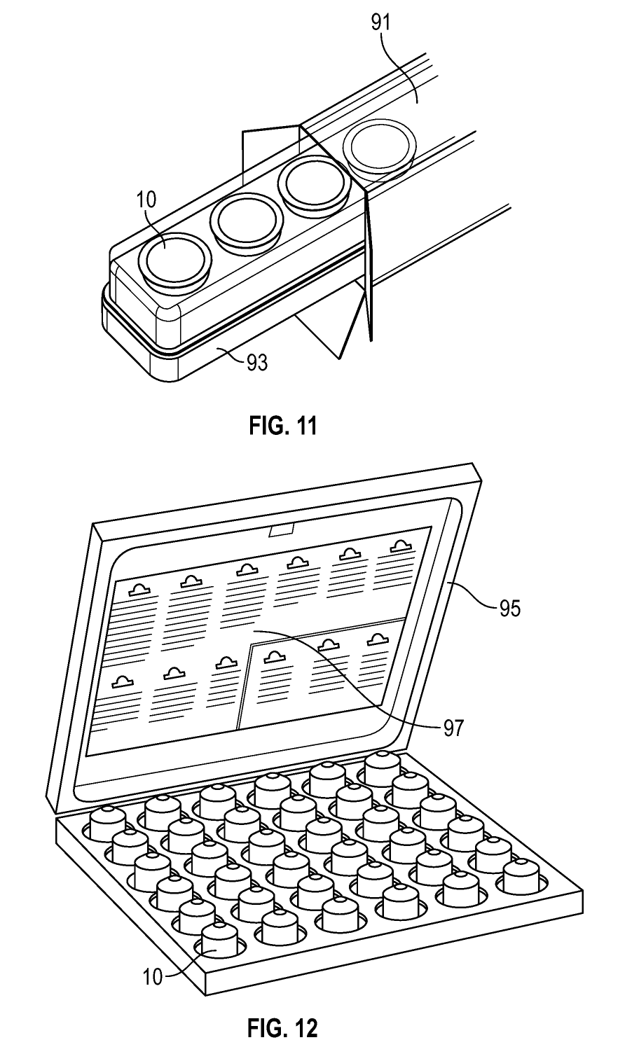

Referring now to FIGS. 5-9, filter assemblies are shown according to various alternative embodiments. The filter assemblies shown in FIGS. 5-9 may be similar in construction to filter assembly 10 except as described herein and/or shown in the FIGURES. Referring to FIG. 5, a filter assembly 60 includes a filter 62, a cover or lid 64, and a support ring 66 (optional) according to an exemplary embodiment. Filter assembly 60 is configured to hold a substance such as coffee granules or the like. Filter assembly may further include an upper flange or lip 70 having a tab 74 extending therefrom. Tab 74 may extend outward from lid 64 to facilitate insertion and/or removal of filter assembly 60 from either a packaging (see FIGS. 6-7) or a suitable brewing device or insert. For example, a packaging such as packagings 76, 77 shown in FIGS. 7 and 8 may provide for a snap fit between packaging 76, 77 and filter assembly 60. As such, tab 74 may facilitate removal of filter assembly 60 from the packaging. In some embodiments, support ring 66 may be injection molded and heat sealed to lid 64, which may be a paper material. Filter assembly 60 may be usable with a brewing device without a separate insert such as insert 30.

FIG. 8 shows a filter assembly 80 positioned within packaging 78 according to an exemplary embodiment. Filter assembly 80 may be similar to filter assembly 60, except that a tab 83 extending outward and downward from lid 84 is configured to be received within a corresponding recess 85 in packaging 78.

FIG. 9 shows an exemplary embodiment of a support ring or stiffener 96 that may be usable with a filter 94 and may further be boned to an additional lid (not shown). Stiffener 96 provides additional structural integrity relative to an annular ring that does not include any interior structural features. The “hub” and “spokes” of stiffener 96 assist in maintaining the shape of the filter assembly during use, while permitting piercing of filter 94 by a suitable brewing device. Stiffener may be made of a polymer material or any other suitable material that provides the desired stiffness and structural integrity to the filter assembly.

It should be noted that according to various alternative embodiments, the filter assemblies shown in FIGS. 7-9 may be configured to use with or without a separate insert, depending on the particular brewing machine being utilized. For example, the top portions of the filter assemblies may be configured to be seated within and seal with a brewing device, and may provide sufficient structural integrity, such that a separate insert such as insert 30 may not be required.

Referring to FIG. 10, a filter assembly 110 and insert 130 are shown according to an exemplary embodiment. As shown in FIG. 10, filter assembly 110 may include a filter 112 and a lid 114. Lid 114 may be made from a semi-rigid paper or cardboard material and may provide a “grip tab” feature to facilitate handling by users. Insert 130 may be a reusable polymer component suitable for re-use with multiple filter assemblies. Insert 130 may be intended to provide additional support for filter assembly 110 during use and further to provide a proper interface with a brewing device such as brewing device 26. Filter assembly may thus be a relatively “green” product made primarily from paper-based products and including a substance such as coffee granules or the like.

In order to maintain the freshness of and prevent degradation of the substance provided within a filter assembly such as filter assembly 10 or the other filter assemblies discussed herein, various packaging options may be used. One option is to seal one or more filter assemblies within a polymer bag or similar container such as packaging 76 (see FIG. 6), such that the polymer bag or container acts as a barrier to prevent moisture, oxygen, or other undesirable elements from entering the interior of the bag. The bag or container may be resealable so as to enable a user to remove one or more filter assemblies and then reseal the bag or container.

A second option involves fitting one or more filter assemblies into an otherwise sealed cavity such that the top of filter assembly 10 forms a part of the barrier between the substance within filter assembly 10 and the environment. As such, a polymer or foil lid may be more suitable for packaging with this second option in place of a paper-based lid. In one embodiment, shown in FIGS. 7-8, one or more filter assemblies may be individually seated within a tray-like container 77, 78. Once properly seated (e.g., via a friction-fit, a snap-fit, or other suitable seating method), the filter assemblies and tray form individually sealed compartments that act as barriers between the substance within the filter assembly and the environment. Packaging 77 may include an ethylene vinyl alcohol (EVOH) material or other suitable material to provide suitable barrier properties for the packaging. Other means of packaging filter assemblies may be used according to various alternative embodiments.

Referring to FIGS. 11-12, filter assemblies such as filter assembly 10 are shown in yet additional packaging options such as packaging 91 (see FIG. 11) and packaging 95 (see FIG. 12) according to exemplary embodiments. Packagings 91, 95 may be suitable, for example, for gift-boxes or similar applications. For example, packaging 91 may provide an outer cardboard box that encloses a tray-like package 93, which as similarly discussed above, may be configured to form seals with the individual filter assemblies 10, or alternatively, provide an overall barrier (e.g., via mating top and bottom sealed components) that effectively “seal in” a number of filter assemblies which may be removed when desired. Packaging 95 shown in FIG. 12 may similarly be configured to receive a number of filter assemblies, and may be a “clam-shell” or other type of packaging that may provide barrier properties to preserve the contents of the individual filter assemblies. In some embodiments, packaging 95 may receive, for example, different types of coffee flavors, etc., such that a label 97 or similar identifier provides users with an indication of the different flavors provided within the packaging. Other types of packaging may be provided according to various other embodiments.

The various embodiments of the beverage filter assemblies, inserts, and other components and methods disclosed herein may provide various advantages to users, including providing a package envelop that comfortably fits into, functions without leakage, and is removable from, various brewing devices; a filter assembly/insert that holds an appropriate volume of substance/granules (e.g. coffee), while being sealed against oxygen, moisture, and/or other undesirable elements; and a filter assembly/insert that further permits fluid to flow in a controlled environment and at a controlled flow rate (i.e., maintaining a sufficient brew chamber during operation) while preventing beverage granules from exiting the pod and entering the beverage. The filter assembly/insert further have a robust design for transportation and storage, are safe for handling (e.g., do not include any sharp edges or hot surfaces), and provide a beverage that is safe for consumption. Various embodiments may further provide a barrier to protect the substance/granules from contamination and degradation prior to and during use, while providing a top surface that is pierceable by appropriate brewing devices.

It is important to note that the construction and arrangement of the elements of the beverage filter assemblies, inserts, and other components and methods as shown in the exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, materials, colors, orientations, etc.) without materially departing from the novel teachings and advantages of the subject matter recited in the various embodiments. Accordingly, all such modifications are intended to be included within the scope of the present disclosure as defined in the appended claims. The order or sequence of any process or method steps may be varied or re-sequenced according to alternative embodiments. Other substitutions, modifications, changes, and/or omissions may be made in the design, operating conditions, and arrangement of the exemplary embodiments without departing from the spirit of the present disclosure.

What is claimed is:

1. A beverage filter kit usable with a brewing device, the kit comprising:
a reusable insert configured to be received within a brewing cavity of the brewing device; and
a disposable filter assembly configured to be received within the insert and comprising a substance suitable for preparing a brewed beverage.

2. The kit of claim 1, wherein the disposable filter comprises a lid coupled to a filter material.

3. The kit of claim 2, wherein the lid and filter material both comprise paper-based materials.

4. The kit of claim 1, wherein the lid comprises a metal foil.

5. The kit of claim 4, wherein the lid is configured to form at least a portion of a gas and/or moisture barrier between the substance and the environment.

6. The kit of claim 5, wherein the insert comprises a top portion configured to register the insert relative to the brewing device in a proper position.

7. The kit of claim 1, wherein the insert comprises a sidewall having a plurality of elongated protrusions extending along at least a portion of the height of the sidewall.

8. The kit of claim 7, wherein the elongated protrusions are configured such that when the filter assembly is positioned within the insert and the brewing device introduces water into the filter assembly, at least intermittent spaces are maintained between the filter assembly and the sidewall of the insert.

9. The kit of claim 1, wherein the insert comprises a hollow post extending from a bottom of the insert, the post configured to receive a brewed beverage exiting from the filter assembly.

10. The kit of claim 9, wherein the post comprises an aperture configured to provide a drain for the brewed beverage to exit the insert.

11. The kit of claim 1, wherein the insert comprises at least one inward-extending recess configured to form an exterior space to receive a piercing member of the brewing device such that the piercing member of the brewing device does not enter the interior of the insert.

12. The kit of claim 11, wherein the recess comprises a plurality of recesses spaced about the bottom of the insert.

13. A filter assembly usable with a brewing device, the filter assembly comprising:
a paper-based lid portion;
a paper-based filter portion; and
a substance contained between the lid portion and the filter portion suitable for preparing a brewed beverage;
wherein the filter assembly is configured to be received within a brewing chamber of the brewing device.

14. The filter assembly of claim 13, wherein the lid portion comprises a resilient material configured to create a seal with the brewing device substantially impermeable to liquid during use of the filter assembly to prepare the brewed beverage.

15. The filter assembly of claim 13, wherein the substance comprises at least one of coffee granules, tea, and cocoa.

16. A reusable insert usable with a filter assembly and brewing device for preparation of a brewed beverage, the insert comprising:
an open top, a bottom, and a sidewall forming a cavity configured to receive a filter assembly, the filter assembly comprising a substance suitable for preparing a brewed beverage;
a plurality of elongated protrusions extending along at least a portion of the sidewall between the top and the bottom; and
an aperture provided on the bottom to provide an exit for a brewed beverage flowing through the filter assembly within the insert.

17. The insert of claim 16, wherein the insert comprises an at least semi-rigid, polymer material.

18. The insert of claim 16, wherein the insert comprises at least one inward-extending recess defining a space exterior to the insert configured to receive a piercing member of the brewing device during brewing of a beverage.

19. The insert of claim 16, wherein the aperture is formed in a hollow post extending downward from the bottom of the insert.

20. The insert of claim 16, wherein the top comprises at least one alignment structure configured to register the insert relative to the brewing device during use.
